(19) United States
(12) Patent Application Publication
(10) Pub. No.: US 2008/0313092 A1
(43) Pub. Date: Dec. 18, 2008

(54) Computerized system and method permitting a buyer to interactively barter/negotiate and arrangement to make a purchase from at least one seller

(75) Inventors: Timothy S. Lanham, Fort Collins, CO (US); Jeffrey T (Ty) Ricker, Lafayette, CO (US); Michael C. Gearhardt, Fort Collins, CO (US); Ralph D. Will, Fort Collins, CO (US)

Correspondence Address: JEAN M. MACHELEDT, 501 SKYSAIL LANE, SUITE B100, FORT COLLINS, CO, 80525-3133, US

(73) Assignee: Mister Money Holdings, Inc.

(21) Appl. No.: 12/214,018

(22) Filed: Jun. 16, 2008

Related U.S. Application Data
(60) Provisional application No. 60/934,644, filed on Jun. 16, 2007.

(51) Int. Cl. G06Q 30/00

(52) U.S. Cl. 705/80

(57) ABSTRACT

A computer implemented process, associated storage medium having program code, and system, for bartering for at least one term relating to the purchase of a product by interacting with a motional graphic displayed on a screen of a client-device. The process includes: (a) displaying a product indicia for each of a plurality of the products; (b) displaying a first pre-recorded motional graphic inviting a user to barter for one of said plurality of the products; (c) displaying offer-request indicia permitting entry by the user of data in connection with the at least one term; (d) in response to entry of first data, using a user interface for the client-device: i) an acceptance price, having been determined for the product by taking into account at least a Low Price set for the product, is displayed; ii) if said first data entered is less than said acceptance price, display a Counter-Offer value, having been determined using a Tier level value associated with the user, along with a second pre-recorded motional graphic. Additionally, if said first data entered is greater-than or equal-to said acceptance price, display a third pre-recorded motional graphic communicating offer acceptance. The first and second pre-recorded motional graphics preferably comprise a clip of a character communicating a respective response.

This application claims priority to pending U.S. provisional patent app. 60/934,644 filed 16 Jun. 2007 on behalf of the assignee hereof for three of the four applicants hereof. To the extent consistent with the subject matter set forth herein, provisional app. 60/934,644 is hereby fully incorporated, herein, by reference for background and technical support.

### BACKGROUND OF THE INVENTION

### Field of the Invention

In general, the present invention relates to computer implemented systems, as well as associated techniques, for selling goods and/or services whereby the buyer need not physically enter a retail outlet to negotiate a price and make a purchase. More-particularly, one aspect is directed to a computerized system and method that permits a buyer to interactively negotiate an arrangement to make a purchase, or otherwise barter, from at least one seller after, first, receiving an offer for a price—which may be discounted from a ‘sticker’/‘list’ or ‘retail’ price—by way of an animated character preferably presented in an unattended manner (without the need for real-time human attention/intervention) through a client-device (personal computer/MAC, personal desk assistant (PDA), cellular telephone, classic telephone, and any other such device adapted for interaction/intercommunication) with which the buyer/user can interact to communicate counter-offers in an effort to reach a deal. In this manner, the user—via visual medium such as a display in communication with a client-device—barters for term(s) of purchase or exchange of a product (item/good or service).

### General Discussion of Technological Areas (By Way of Reference, Only)

One attempt to discuss an on-line interactive computer-implemented system, is shown in U.S. Pat. No. 6,035,288. This system employs what was coined by the inventors as “emotional response matrix” of possible states of emotion a merchant selling a product can display, on a site on the World-Wide-Web where simulated human merchants present goods for sale at negotiable prices and interact or “haggle” with customers until either an agreed price is arrived at or one party terminates the negotiation process. A high-level schematic of a conventional distributed network environment for use to implement this earlier system is shown in FIG. 1. There are websites currently in use that employ an animated human video clip whereby the human enters a screen for purposes of advertising some product.

### Computerized Devices, Memory & Storage Devices/Media.

I. Digital computers. A processor is the set of logic devices/circuitry that responds to and processes instructions to drive a computerized device. The central processing unit (CPU) is considered the computing part of a digital or other type of computerized system. Often referred to simply as a processor, a CPU is made up of the control unit, program sequencer, and an arithmetic logic unit (ALU)—a high-speed circuit that does calculating and comparing. Numbers are transferred from memory into the ALU for calculation, and the results are sent back into memory. Alphanumeric data is sent from memory into the ALU for comparing. The CPUs of a computer may be contained on a single ‘chip’, often referred to as microprocessors because of their tiny physical size. As is well known, the basic elements of a simple computer include a CPU, clock and main memory; whereas a complete computer system requires the addition of control units, input, output and storage devices, as well as an operating system. The tiny devices referred to as ‘microprocessors’ typically contain the processing components of a CPU as integrated circuitry, along with associated bus interface. A microcontroller typically incorporates one or more microprocessor, memory, and I/O circuits as an integrated circuit (IC). Computer instruction(s) are used to trigger computations carried out by the CPU.

II. Computer Memory and Computer Readable Storage. While the word ‘memory’ has historically referred to that which is stored temporarily, with storage traditionally used to refer to a semi-permanent or permanent holding place for digital data—such as that entered by a user for holding long term—more-recently, the definitions of these terms have blurred. A non-exhaustive listing of well known computer readable storage device technologies are categorized here for reference: (1) magnetic tape technologies; (2) magnetic disk technologies include floppy disk/diskettes, fixed hard disks (often in desktops, laptops, workstations, etc.), (3) solid-state disk (SSD) technology including DRAM and ‘flash memory’; and (4) optical disk technology, including magneto-optical disks, PD, CD-ROM, CD-R, CD-RW, DVD-ROM, DVD-R, DVD-RAM, WORM, OROM, holographic, solid state optical disk technology, and so on.

III. Widgets. Widgets are a class of ‘client-side’ applications—those generally targeted for transfer via the World-Wide-Web (or, ‘web’) and run on a client-device—that facilitate the display and/or updating of local or remote data. Widgets are often packaged such that a single download and installation onto a client machine/device (personal computer, mobile phone or internet device, often referred to, simply, as ‘cell’) is generally all that is required in order to run the widget from the client-device. Widgets can run as stand-alone applications outside of a web browser application (e.g., Internet Explorer, Netscape, etc.), or can be created for embedding into a web page so that the widget runs when the webpage is opened. Examples of widgets include a time clock display icon that keeps time, stock tickers, news casters that update headline news on-the-fly, games, and weather forecasters, to complex applications that pull data from multiple sources to be presented to a user in some useful way.

### Selected Definition(s) Included by Way of Further Background Reference.

Barter: to negotiate or argue over one or more term of a transaction (e.g., a purchase of item(s)/good(s)/financial product, or service(s) using legal tender such as cash/currency, check/draft, debit card, money order, gift card, electronic/wire transfer from an active account, etc., or made on-credit such as via credit card, etc.; or an exchange of goods or services in return for other goods or services, and so on).

### SUMMARY OF THE INVENTION

Briefly described, once again, are novel computerized system, associated method as well as storage medium having program code. The system, method and program code permit a buyer to automatically yet interactively negotiate an arrangement to make a purchase or exchange, or otherwise barter, after first receiving an initial offer concerning a product being offered by a selling entity/seller—such as an offer of a price, which may be initially discounted from a ‘sticker’/‘list’ or ‘retail’ price. The bartering is done by way of a motional graphic, preferably including a character (a motional graphic consisting of a pre-recorded video/movie clip of a human or other animal, an animated cartoon of a full character or portion thereof, e.g., hands or mouth, a stick-person or stick-critter, and so on) preferably presented in an unattended manner (without the need for real-time human attention/intervention) through a client-device (personal computer/MAC, personal desk assistant (PDA), cellular telephone, classic telephone, and any other such device adapted for interaction/intercommunication) with which the buyer/user can interact to communicate counter-offers in an effort to reach a deal. The product can be an item/good, a financial product such as a short term lease or loan, or a service. In this manner, a user—via visual medium such as a display in communication with a client-device—barters for one or more terms such as purchase price, or exchange, of a product (item/good or service) with a motional graphic (such as a character responding in pre-recorded clips) in a manner that takes into account:

(a) each respective offer entered by a user throughout the negotiation session/epoch;

(b) a Low Price (i.e., a bottom price considered acceptable by the entity offering the product, for example, a lowest price seller is willing to accept under current circumstances);

(c) an early-acceptance price based upon the Low Price and a list/retail price (i.e., a high-side price very near list price); and

(d) if the early-acceptance price is not accepted by the user, a Tier level value—for use during the current negotiation session to determine respective Counter-Offer values—is determined by taking into consideration a plurality of qualitative criteria.

### BRIEF DESCRIPTION OF DRAWINGS/INCORPORATION OF ATTACHMENT(S)

For purposes of illustrating the innovative nature plus the flexibility of design and versatility of the new system and associated technique, the figures and certain background materials, if any, labeled “ATTACHMENT ______”, are included. One can readily appreciate the advantages as well as novel features that distinguish the novel process and system contemplated hereby from conventional computer-implemented interactive selling techniques. The figures as well as any incorporated technical materials have been included to communicate the features of applicants' innovation by way of example, only, and are in no way intended to limit the disclosure hereof. Any enclosure labeled an ATTACHMENT, is hereby incorporated herein by reference for purposes of providing background technical information.

FIGS. 1A, 1B, 1C, 1D, and 1E each depict computer implemented purchase-offer displays: FIGS. 1A and 1B illustrate one example of a motional graphic—in this case character 12a, 12b—with which a buyer/user who is interacting with display 10a or 10b, can negotiate. FIGS. 1C and 1D illustrate one example of how a character can be selected from a group of choices 16d to participate in the motional graphic used for bartering. FIG. 1E illustrates a product indicia that can be ‘clicked’/‘double-clicked’/tapped/pressed-keyed, or otherwise activated, to select a product using known mouse, keyboard, or touch-screen user interface technology, so the user can enter or start a negotiation epoch/session.

FIGS. 2A, 2B, 2C, and 2D each depict displays during a negotiation epoch/session, as herein described. While the character is presented as a human video, it need not be. Animated characters or portions of characters (e.g., cartoons, a head of a cartoon character, etc) can be employed as part of the motional graphic displayed to communicate instructions/process steps/screen display features, or otherwise entertain.

FIG. 3 is a high-level system schematic representing intercommunication of elements of a system that may be employed to carry out the invention.

FIG. 4 is a high-level flow diagram depicting features of an embodiment/technique 40 for bartering, or otherwise negotiating, one or more terms of an arrangement between a buyer/user and at least one seller/offeror, according to the invention.

FIGS. 5, 6, and 7 each depict sub-processes, or modules, of the FIG. 4 diagram as shown therein.

FIG. 8 is a high-level flow diagram 140 depicting features of an embodiment/technique for bartering, or otherwise negotiating, one or more terms of an arrangement between a buyer/user and at least one seller/offeror, according to the invention.

FIG. 9 is a high-level flow diagram 160 depicting further features that detail the technique suggested by FIG. 8.

FIGS. 10 and 11 each depict displays containing consecutive widget displays 130a, 130b introducing a negotiation epoch/session within a host web display 110a, 110b.

FIGS. 12A, 12B, 12C, 12D, 12E, and 12F each depict computer implemented purchase-offer displays which illustrate one example of a motional graphic—in this case character 122a-122f—with which a buyer/user who is interacting with display 120a-120f, can negotiate.

### DESCRIPTION DETAILING FEATURES OF THE INVENTION

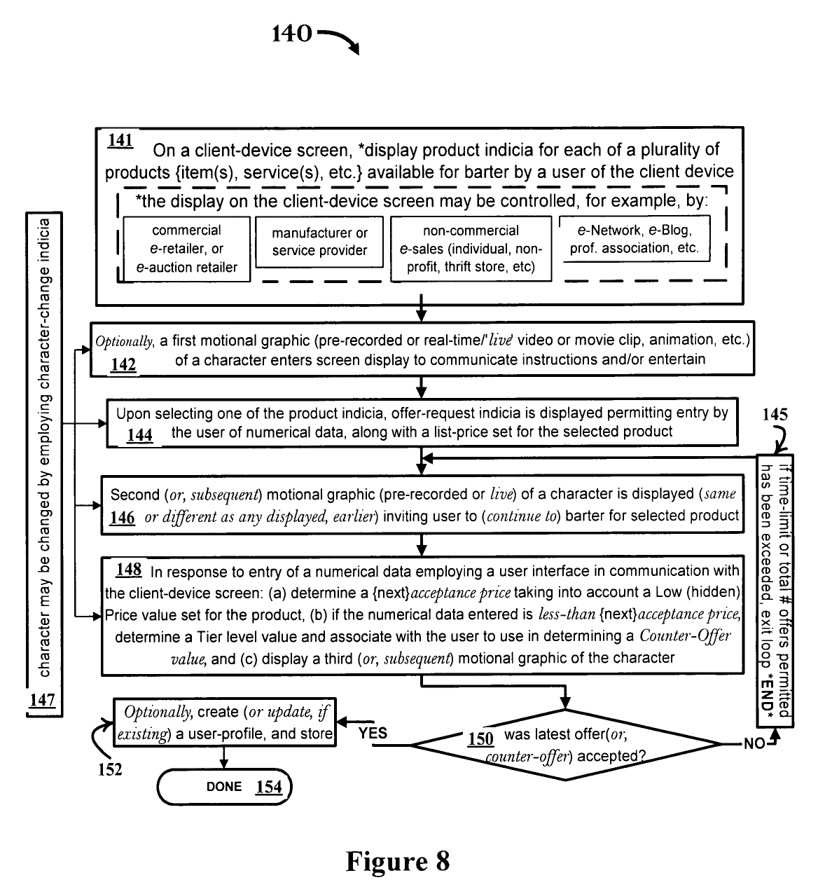

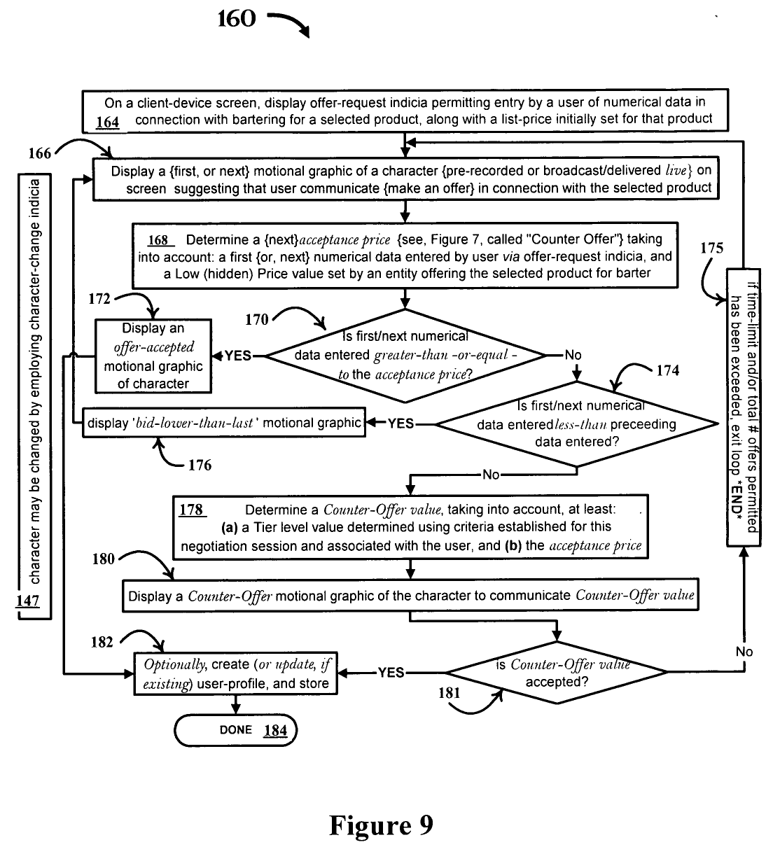

By viewing the figures incorporated below, and associated representative embodiments, one can further appreciate the unique nature of core as well as additional and alternative features of the new system and associated technique for negotiating with a buyer. Back-and-forth reference and association will be made to various features identified in the figures—especially the flow diagrams in FIGS. 8 and 9 which include core, as well as additionally unique, features of the unique process.

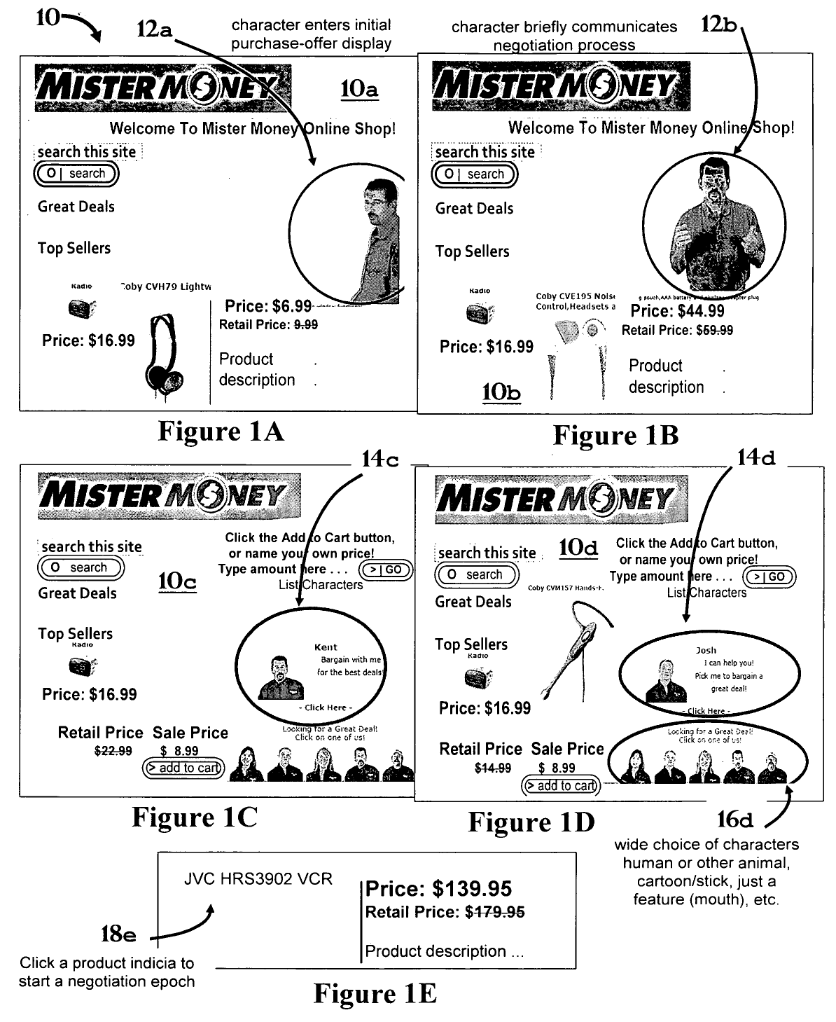

FIGS. 1A-1E each depict computer implemented purchase-offer displays on screen 10: FIGS. 1A and 1B illustrate one example of a motional graphic—in this case character 12a, 12b—with which a buyer/user who is interacting with display 10a or 10b, can negotiate. A selected character 12a enters the view area 10a upon opening a local application, or opening a selected webpage, to communicate with the user. For example, once in-position on the display 10b, character 12b motions and/or communicates verbally to suggest that the user, likewise, communicate to make an offer employing the user interface to selected product (item/good, service, etc.). FIGS. 1C and 1D illustrate one example of how to change a character such as going from character 14c to 14d by clicking/activating a graphic associated with one from a group of choices 16d. Once selected, or re-selected, the character either becomes or participates in the motional graphic. FIG. 1E illustrates one example of product indicia 18e that can be clicked/double-clicked/tapped/entered-keyed, or otherwise activated, to select one of the products illustrated, such as is done using known mouse, keyboard, or touch-screen user interface technology. Once a user clicks or otherwise activates a selected product indicia, preferably a more detailed description is displayed in connection with the selected product to enter/start a negotiation epoch/session (see, also, 144, FIG. 8, and 164, FIG. 9).

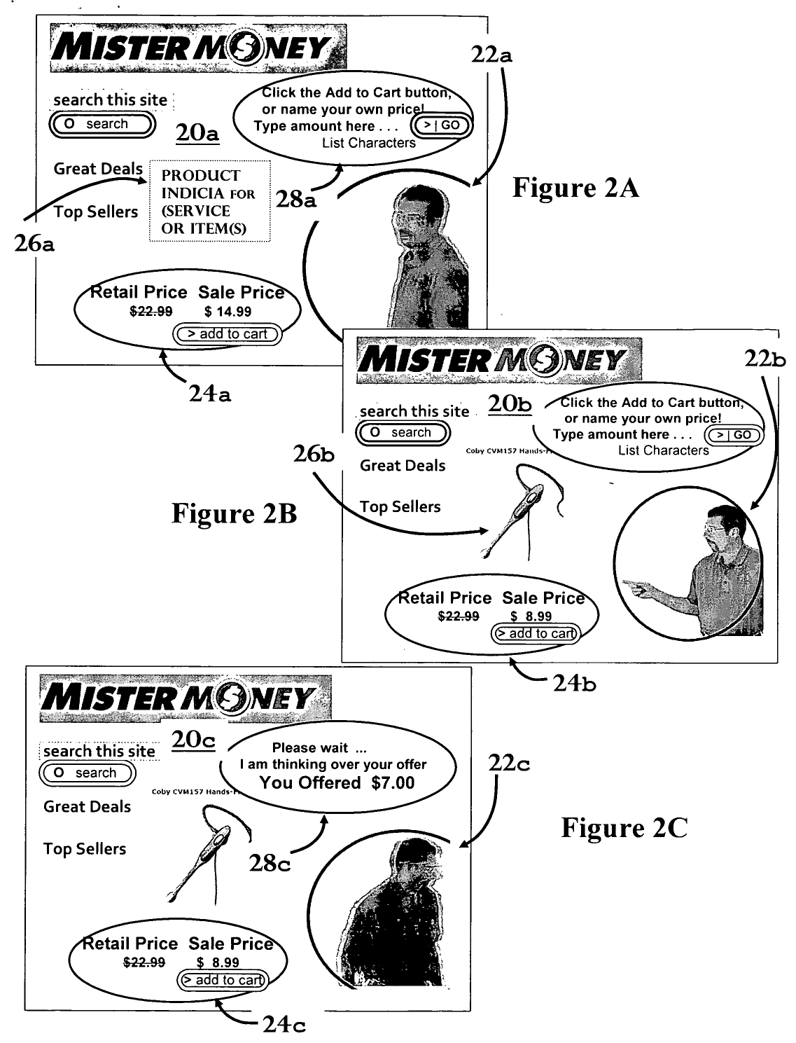

After displaying entry and intro-motional graphics 12a, 12b (FIGS. 1A, 1B) consisting of a video or movie clip of the character chosen from group 16d, and clicking on (activating) product indicia 18e, negotiating/bartering can begin. FIGS. 2A, 2B, 2C, and 2D each depict displays during an example negotiation epoch/session. While the character is presented as a human video, it need not be. Animated characters or portions of characters (e.g., cartoons, a head of a cartoon character, etc.) can be employed as part of the motional graphic displayed to communicate instructions/process steps/screen display features, or otherwise entertain. As shown: The character/theme shown in FIGS. 2A-2D at different positions 22a-22d, is either that which was automatically selected for display, or that which is manually selected by a user (not shown) interacting with the displays 20a-20d from displayed choices (e.g., 16d). As shown by way of example here, character 22a re-enters display 20a to communicate a willingness to barter/negotiate over the product described by product indicia 26a by having the user enter numerical data at 24a/28a to counter the initial offer price shown as a list/retail or sale price 24a. In FIG. 2B, character 22b further entertains the user while deciding, e.g., tells a joke, explains key features of the product highlighted by indicia 26b, or explains that the most-recent counter-offer price is being displayed at 24b (pointing in the direction). Character 22c of FIG. 2C communicates that it is ‘leaving’ the display to seek permission from a seller offering the product, as to whether the last numerical data (counter-offer amount) entered by user at 24c is acceptable, or still too high. In addition to verbal/audio communication, alphanumeric characters at 28c, 28d include a script of what the character is ‘saying’. As shown in display 20d, FIG. 2D, the last entered numerical data (counter-offer amount made by user at 24d) was accepted 28d to purchase product 26d, as communicated by character 22d. Additionally, character 22d points to indicia 28d requesting identification (e.g., email address, or ID number, or such) of the user/buyer; and can further be programmed to automatically explain steps the user must now take, e.g., ‘click here to enter further data’ so that a new display will follow indicating acceptance by both the seller and the user/buyer of the last counter-offer value entered 24d.

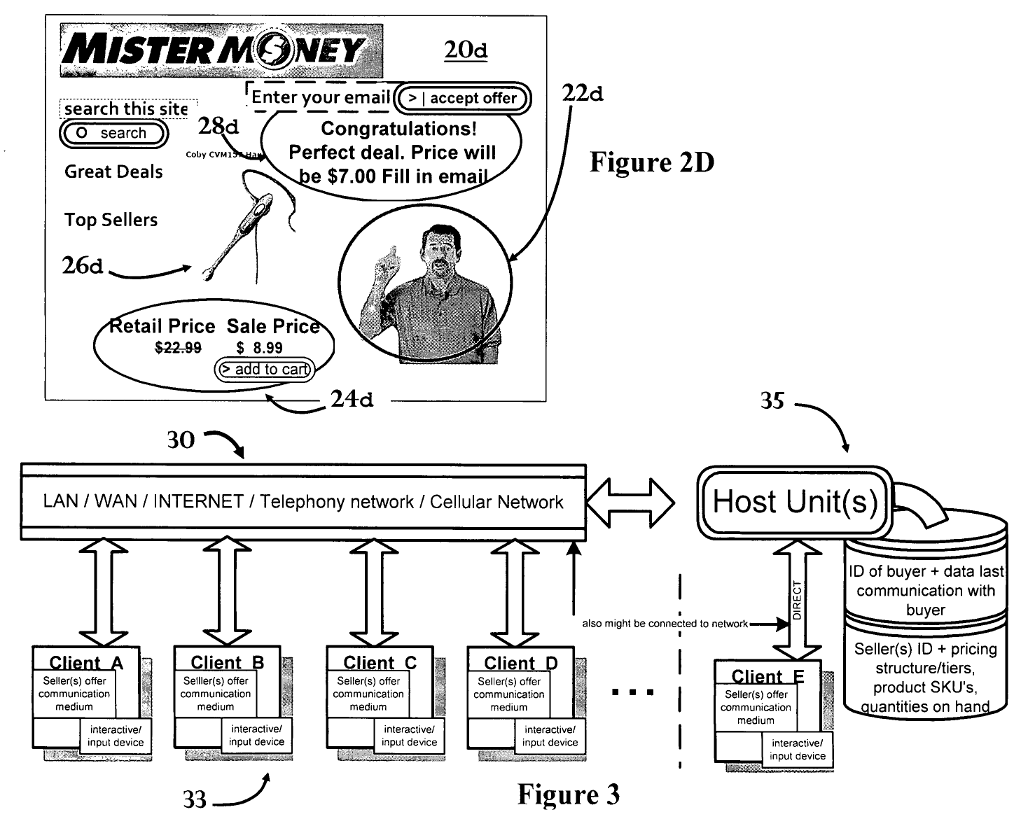

The high-level system schematic in FIG. 3 represents intercommunication of elements of a system 30 that may be employed to carry out the invention. This diagram shows interconnection of several available client-devices 33 (“Client A-E”) at which a user/buyer may communicate his/her/their/its counter-offer(s), interactively as explained herein, to an unattended seller-controlled character displayed at “Seller(s) offer communication medium”, through a respective “interactive/input device” as labeled. The host device 35 (“Host Unit(s)”) is used to control the unattended character: That is to say, system component 35 Host Unit(s) represents a host processor location (or, locations with processing units in communication) where a multitude of unique pre-programmed audio-video/movie clips are stored and available for ready display when called-up by a widget app, each clip containing content permitting seemingly-instantaneous appropriate response to a user input, as well as access to a database of products (items/goods and/or services), list/retail and Low Price values for each, and other terms of barter (whether as an outright purchase for legal tender, or an exchange of good for good, service for good, service for service, and so on). As also noted, host processor preferably has ready access to information stored concerning user/buyers (ID's of each user, along with info regarding last negotiation session with the user), and information from each offeror/seller in control of the displays (see FIG. 8, at 141) including criteria for pricing structures/Tiers (FIGS. 8, 9 at 148, 178), product SKU's, quantities of product on-hand, prospective ship dates, tax and shipping assessments, and so on. Host Unit(s) 35 may be physically remote from a respective client-device 33 so as to communicate via “LAN/WAN/INTERNET/Telephony network/Cellular Network”, or in ‘direct’ communication with Host Unit(s) 35, as is suggested for Client E, which might be in same or nearby room as Host Unit and either physically hardwired or in communication via wireless, IR port, or such. As one can appreciate there is wide flexibility afforded by the unique technique and system contemplated for auto-bartering for purchase or exchange of products, to utilize current network structures, peripheral devices, personal computing devices (PDA's, PC's, iPods, cell phones) capable of accepting data from a user and uniquely displaying the motional graphics in an entertaining way during negotiation.

It is contemplated that client-devices 33 (Client A-E) can be of a wide variety of types: PC/MAC, personal desk assistant (PDA), cellular phone, telephone, kiosk, or any other device through which an offer can be communicated to a buyer from an unattended character displayed (video/movie clip, projected hologram, etc.) to offer a product for purchase (item, financial product, service, batches of items, etc.). By way of bartering with a motional graphic, such as a character composed of video, ‘rich’ content or something lesser (preferably with audio though not critical, human or animated cartoon/stick feature), a buyer/user at a client device can negotiate an arrangement to purchase a selected product offered via the display.

The instant process offers additional flexibility of use, as a buyer may enter a negotiation epoch at one of the client-devices 33, then continue at a different client to reenter a barter/negotiation session/epoch that has not yet terminated/expired. For example: The user/buyer may start a barter epoch from his computer at home; then travel elsewhere, say, a terminal/kiosk/client physically unconnected to his home computer, to re-enter latest, or restate, negotiation epoch (time during which negotiations remain ‘open’ for the initial product—item(s) or service—for which the buyer is negotiating). A negotiation/barter epoch—for purpose of discussion herein—includes a total period of time from initial engagement of the buyer to receive an initial offer communicated by the seller(s), through the mid-epoch/multiple-session (which may include more than one mid-epoch session, each could be entered via different client-device) consisting of haggling or bartering back-and-forth with a character, and eventually terminated by either buyer closing (gets to the point where “I simply don't want to buy this from this seller(s) at this point in time”) or seller(s) algorithm times-out, or a total permissible number of counter-offers from a user during a negotiation/barter session has been reached (represented in FIGS. 8, 9 at 145, 175, respectively); for example, the entity controlling a display session (see FIG. 8 at 141) preferably cuts off back-and-forth negotiation with a user after a reasonable total number of times that user's counter-offer data has been accepted and ‘considered’ by a character. See, for instance, FIG. 8 flow diagram loop starting at 150, through 145, and returning to at step 146 and FIG. 9 flow diagram loop starting at 181, through 175, and returning to step 166.

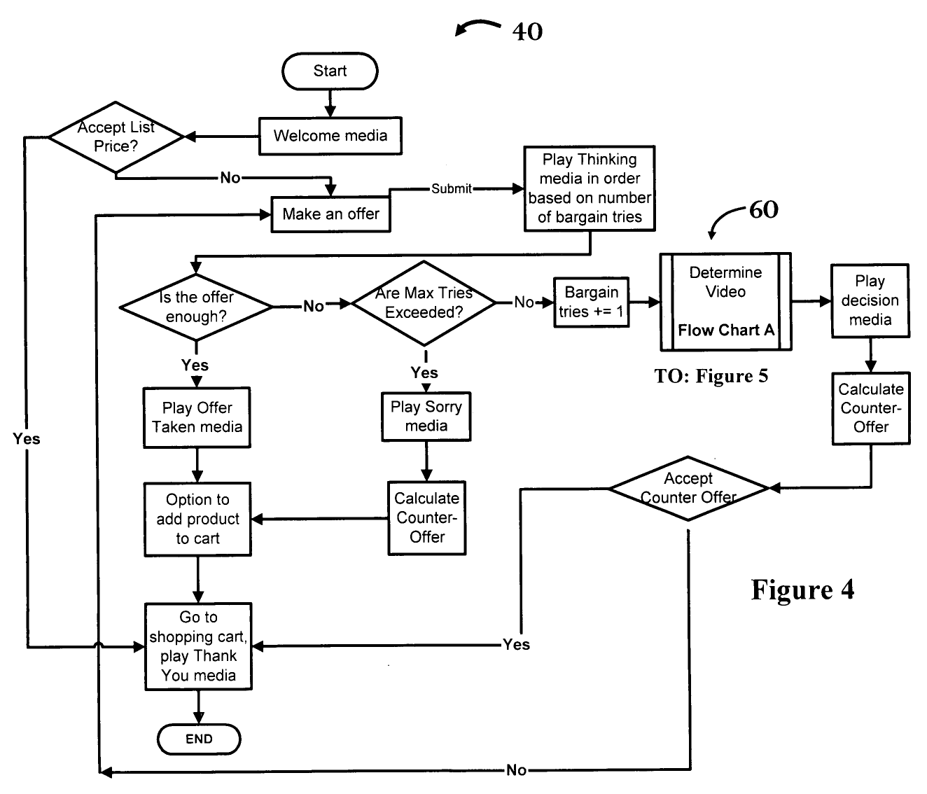

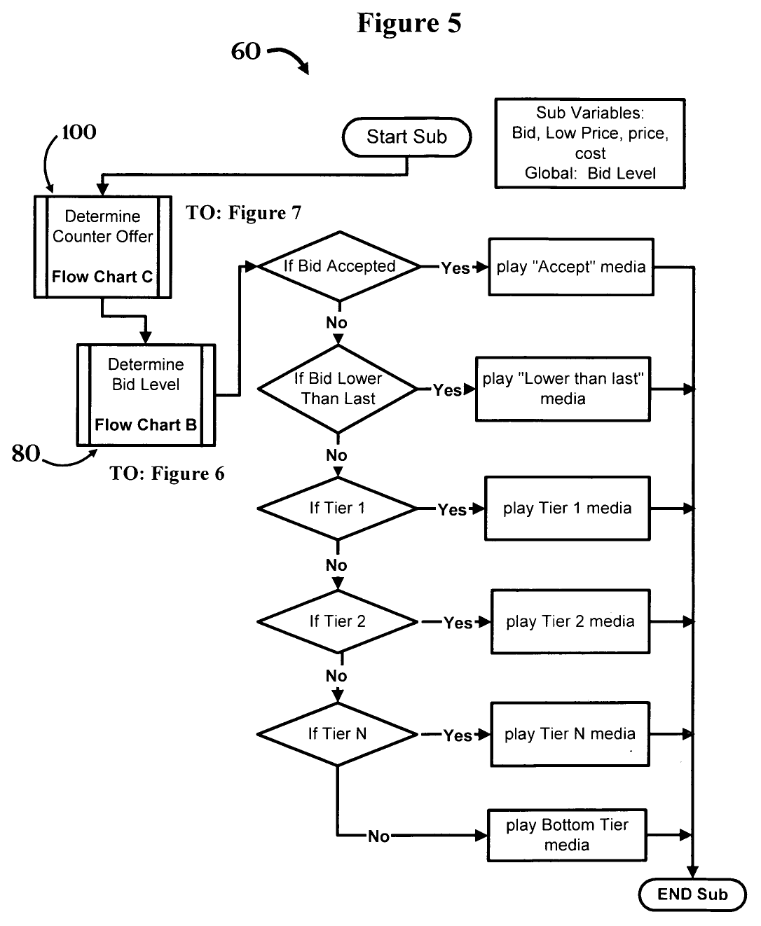

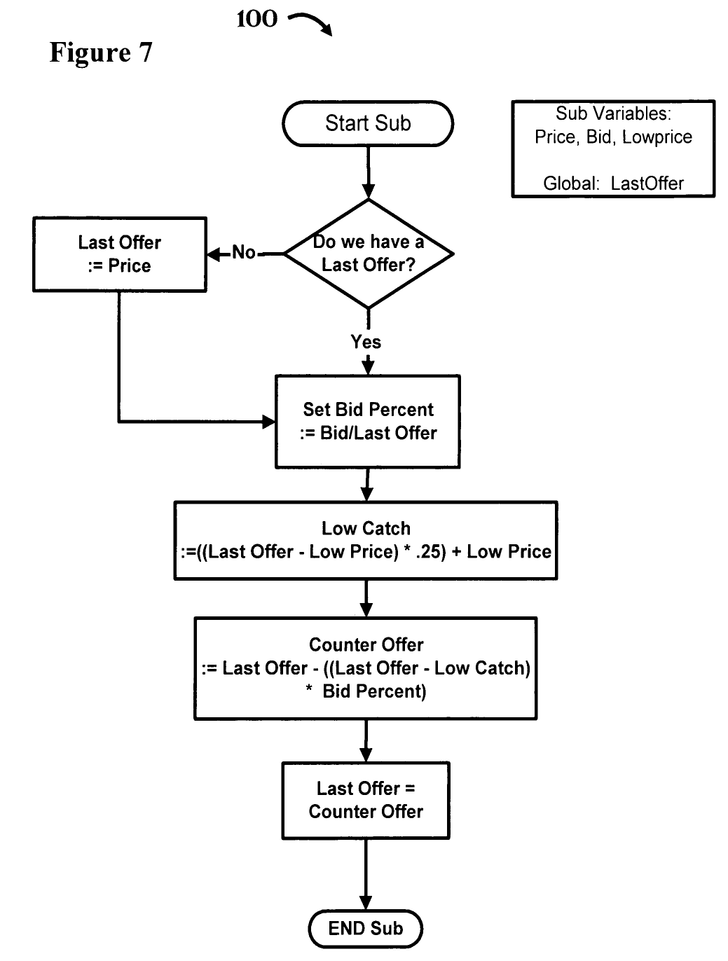

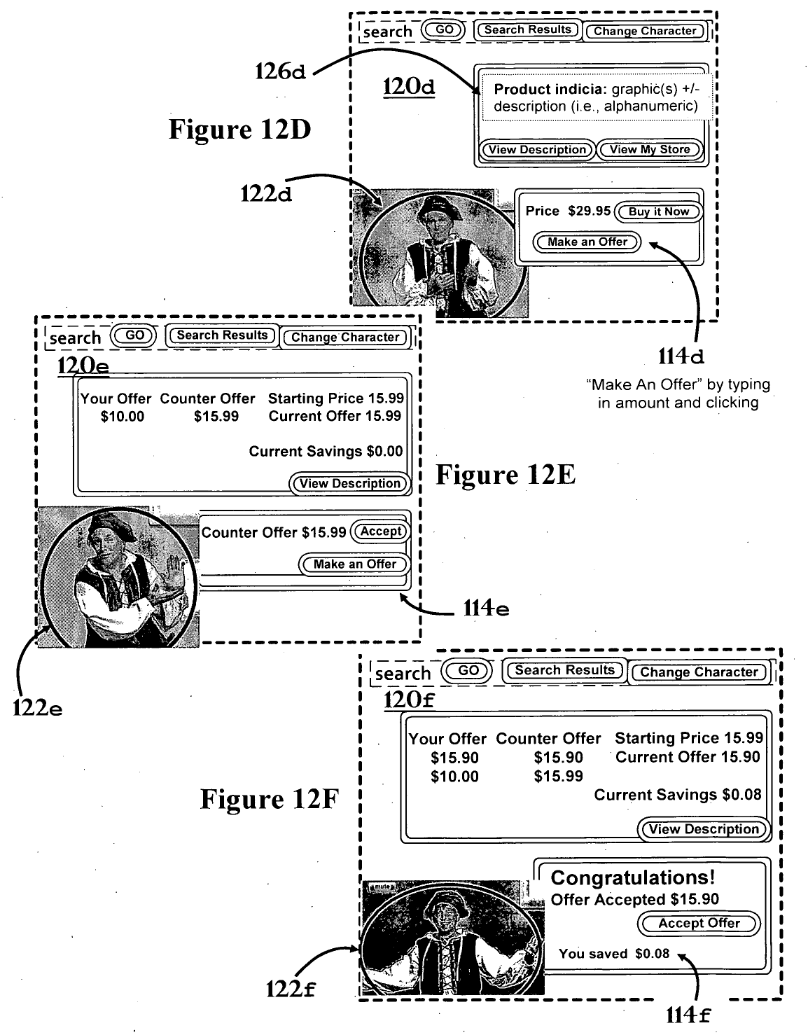

FIG. 4 is a high-level flow diagram depicting features of an embodiment/technique 40 for bartering, or otherwise negotiating, one or more terms of an arrangement between a buyer/user and at least one seller/offeror (here, purchase price is undergoing barter). Shown are core, as well as additionally unique, features. In an environment where the focus is to barter, process 40 permits a user to accept a list/retail price (suggested by displays shown in FIGS. 1E, 2A at 24a, and 12A-12D at 128a-128c, 114d) however unlikely first-off acceptance might be. Flow of steps, each labeled clearly, leads to step 60 called “Determine Video”, which is where the sub-processes, or modules, depicted by FIGS. 5, 6, and 7 are considered. Prior to calculating a Counter-Offer value (see, also, FIG. 9 at 178) for process 40, an early-acceptance price is calculated by employing a series of steps such as those shown in FIG. 7 at 100 (the variable name “Counter Offer” has been assigned to the value resulting from sub-routine 100). This is in effect, an early-acceptance price; a price that takes into consideration the difference between a Low Price value (sometimes referred to as ‘hidden’, or ‘rock-bottom’ price) set for the product by the seller (FIG. 8, 148 and FIG. 9 at 168), and the numerical data entered by a user to communicate a first-offer after having seen an initial list/retail/‘sale’ price displayed (FIG. 2A at 24a, FIGS. 12A-D at 128 a-c, 114d). A small percentage, say, under 5-10%, of this difference is subtracted from the initial list/retail/sale price to arrive at an early-acceptance price. Acceptance by a user of an early-acceptance price (FIG. 8 at 150, and FIG. 9 at 170, 172) permits a user to exit a barter session, quite early-on (DONE 154, 184). The quick-barter early-acceptance price process 100 can be tailored for on-the-fly adjustment where a product is earmarked to move for reasons such as end-of-season color, style, model, small quantities in stock, replacement parts being phased-out, and so on.

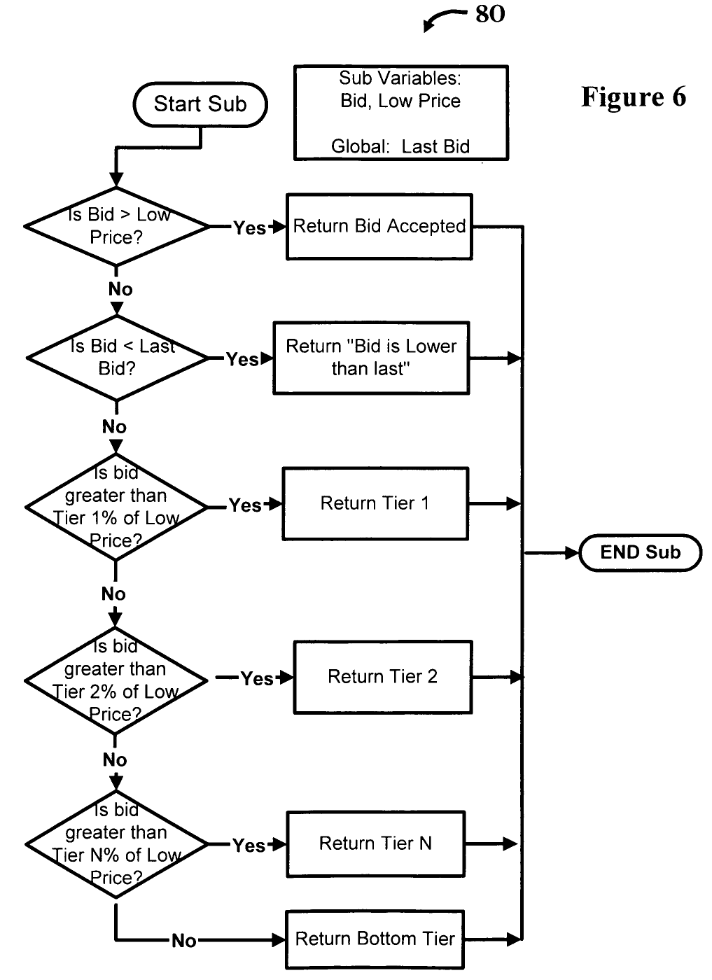

FIGS. 5 and 6 are considered, together, as the two subroutines 60 and 80 overlap to a certain degree. Sub-modules 60, 80 reflect the novel use of a plurality of Tier pricing levels based upon criteria set by a seller, which help categorize how good of a deal a seller is willing to settle for utilizing an unattended character with a given user. The Tier level value determined and associated with a particular user (under current circumstances), is then used to determine the Counter-Offer value (FIG. 8 at 148, FIG. 9 at 178, and FIG. 12E at 114e) offered by a character/motional graphic. The use of automatically assessing a Tier level based on a plurality of criteria, aids in lending a personalized quality to the bartering/negotiating being done by an unattended character. While Tier level calculations are made and applied generally over the whole negotiation session, and to a certain degree affect how good a deal a current user may get, Tier levels coupled with the amount of control permitted a user during the barter epoch, as explained elsewhere, and the clever pre-recorded motional graphics displayed after user enters data/input, make the process an extremely valuable tool for both entities bartering for a deal. A user controls their barter environment in the following ways: (a) the character's theme can be changed 147 based upon who the user is more-comfortable bartering with and/or whether the user is hoping to be entertained (character themes permit pre-recorded responses that may be goofy, truly funny, serious, western-style, nautical sailor, English Lord, college-age student, athletic coach, older grandmotherly advisor, and so on); (b) user may leave the process and reentering at a later time (say, moving from a noisy place to a quieter home-office); (c) a different product can be selected for barter if a current product negotiation is not moving in a direction suitable to the user; and so on. While sub-modules 60, 80 depict three Tier levels, by way of example, the total number is not critical, and may be seller-driven (from two to a multitude of Tier levels, may be defined).

Tier level criteria that may be taken into account, and applied, when determining a Tier level value for association with a current user, include: Is current user a repeat customer? Is user registered with the entity controlling the displays (FIG. 8 at 141)? Does the current user have a good record with the seller in past bartering sessions? What is/are the environment/market considerations under which the product being bartered for, is being offered? For example, is bartering taking place before or after a Holiday? What is the time left in barter epoch? What is the time of day, time of the year/season/weather? Is today a special event sales day? Is the seller a high-volume sales entity for this product? Does the product have a longstanding history of healthy sales, or is it undergoing new product entry into the market? Is it an item/good at over-stock quantities? What is the condition of the product, especially if it was pre-owned or ‘used’? Is the user part of a social network, recreational association/club, professional association, a student body, volunteer organization, or affiliated with a frequent buyer club, and so on?

Tier level values are preferably calculated by taking into account one or more of the following factors/criteria, outlined generally below. Also listed are example character replies as well as other considerations that can be built into the process to further personalize the barter experience:

A. Margin (Relates to Term(s) Offered for Barter, from a Seller's Perspective)

i. List/retail/sale Price (might be crossed-out on screen so user can still see, and in proximity to an initial early-acceptance price (“Buy it right now for this {slightly discounted} price!”)

ii. Low Price (Seller's hidden price, or rock-bottom price, set by seller permanently or temporarily, as may change according to date, e.g., end-of-season, or stock on-hand, etc.).

iii. early-acceptance price is preferably determined by calculating a difference between the last/current offer (or, counter) by a user—and if none yet entered by user, use the List/retail/sale price—and the Low Price (“Buy it right now for this slightly discounted price!”)

iv. Counter-Offer value is determined and communicated by character if early-acceptance price is not (FIG. 4, right-hand side of diagram, FIG. 8 at 148, FIG. 9 at 170, 178, and 180).

### B. The User/Buyer's Offer(s) and Counter(s) Made During Negotiation Session/Epoch

i. Way too low (“The offer you've entered is out-of-range, please try again!”)

ii. Lower than last (subsequent offer entered by a user is even less than a rejected prior offer entered: “Please check your offer, as this is even less than your last offer, and try again.”)

iii. Close (“Your latest offer is almost there, we can't accept it, but can accept this {Counter-Offer value} price, instead!”)

iv. Acceptable (“Congratulations! We accept! You got a great deal!”)

v. Unacceptable (“Sorry, but you can accept our final offer.”)

C. Conditions (Epoch/TIME period of current session)

i. Price of Product (to include items/goods, including financial products such as short term loans where rate might be negotiable, as well as a very wide range of services)
a. List/retail/sale Price (may already discounted a great deal, depending on seller's motivation to move merchandise, or not)
b. Starting Bid (suggest bid, right off, of early-acceptance price, e.g., “List is $3.99, but if you bid $2.79, right now, it's yours!”)
c. Margin (Wish we could offer better but this is a low margin item)

ii. Moment
a. Day of Week (Monday's Special)
b. Date of Month, Year (End of Month, end-of-season with overstocks)
c. Event (Upcoming, or the date of, a Holiday, or special sales event, etc.)

iii. Quantity
a. Limited Availability (Only 3 Left)
b. Surplus Availability (Overstock)
c. Number of Units (Large Lot, inventory/stock declining or increasing, etc.)

iv. Seller
a. New Seller (Risk/Opportunity)
b. Known Seller (Less Risk)
c. Premium Seller (Qualified, High Volume, etc.)

v. Condition
a. New
b. Used (Mint, Good, Fair, Poor, etc.)
c. Other (Certified by manufacturer to meet applicable standards)

vi. Buyer
a. New Buyer (Risk/Opportunity)
b. Known Buyer (Registered)
c. Premium Buyer (Qualified, High Volume, etc.)

vii. Referral
a. Unknown
b. Known (IP Address, Site: Google, Yahoo, etc.)
c. Network (Facebook, MySpace, Organization, etc.)

viii. Demand
a. Little Demand (“You can be the first to bid!”)
b. Great Demand (“Wow look at all those bids, don't lose out.”)

ix. Terms
a. Payment (Paying by cash, credit card, gift card, and other legal tender) to purchase outright.
b. Credit (No money down, no payments until ______ date!)
c. Additional Purchases (“Buy a warranty and we'll throw in an offer to sell the product for $X!”)
d. Bonus (“Accept this offer and we will throw in a peripheral for free!”)
e. Trade or exchange of products (item/good or services)
f. Partial Ownership/short term Rental of product

x. Other
a. Random (“Congratulations! You are the X-th person to make an offer and because of this, you've received our slashed-price!”)
b. Fixed Override for split or multi-variable testing

Considering technique 40, FIG. 4 (box labeled “Calculate Counter-Offer”) in concert with those labeled 140 and 160 (particularly, FIG. 8 at 148, 150 and FIG. 9 at 178, 180, 181): One can appreciate that the Counter-Offer value determined and communicated to a user may, or may not, be accepted by the user during a barter epoch. As mentioned above, if a last offer/counter-offer is not accepted (150, 181), and if the total number of offers permitted by a user has not been used-up and a time-allotted for the current barter session/epoch has not yet passed (FIG. 8 at 145 and FIG. 9 at 175), a motional graphic is displayed inviting the user to continue bartering/negotiations (FIG. 8 at 146 and FIG. 9 at 166). On the other hand, once a latest offer/counter-offer is accepted (150 to 152 and 181 to 182), optionally, a user-profile can be updated or, if none exists, created to provide information concerning details of the current negotiation session (process 140, 160), for storage and use in determining frequent user status, etc., as it relates to criteria used in determining Tier level values (see FIGS. 5 and 6, as well as FIG. 8 at 148 and FIG. 9 at 178) to be assigned to this user should it return for more bartering/negotiations.

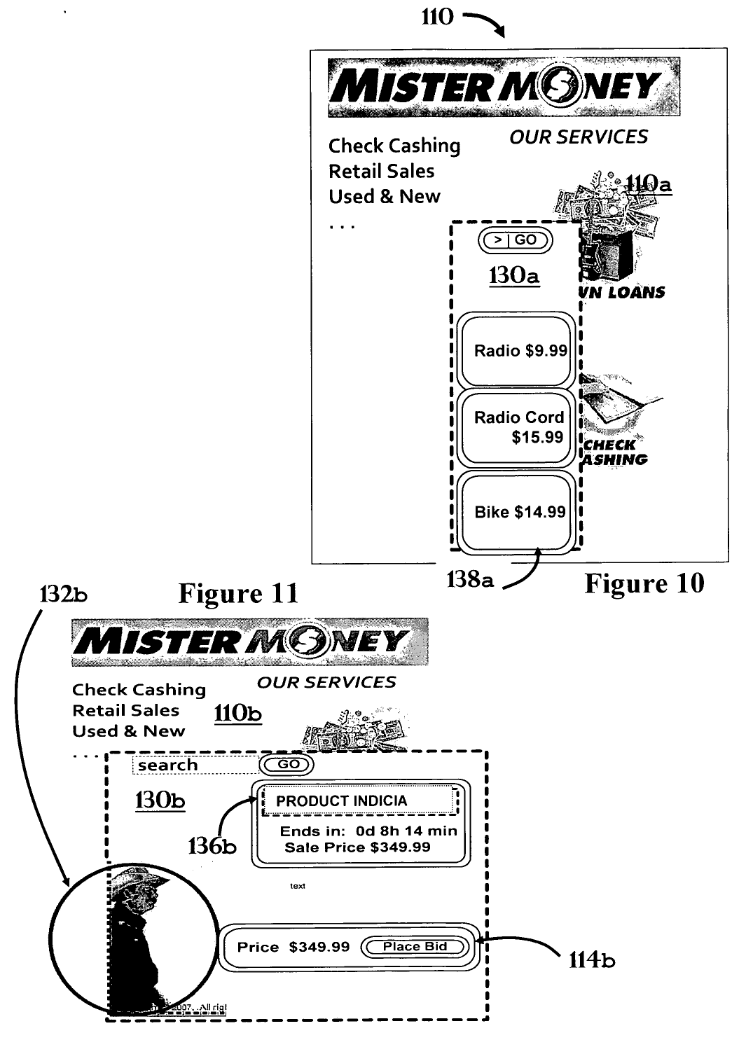

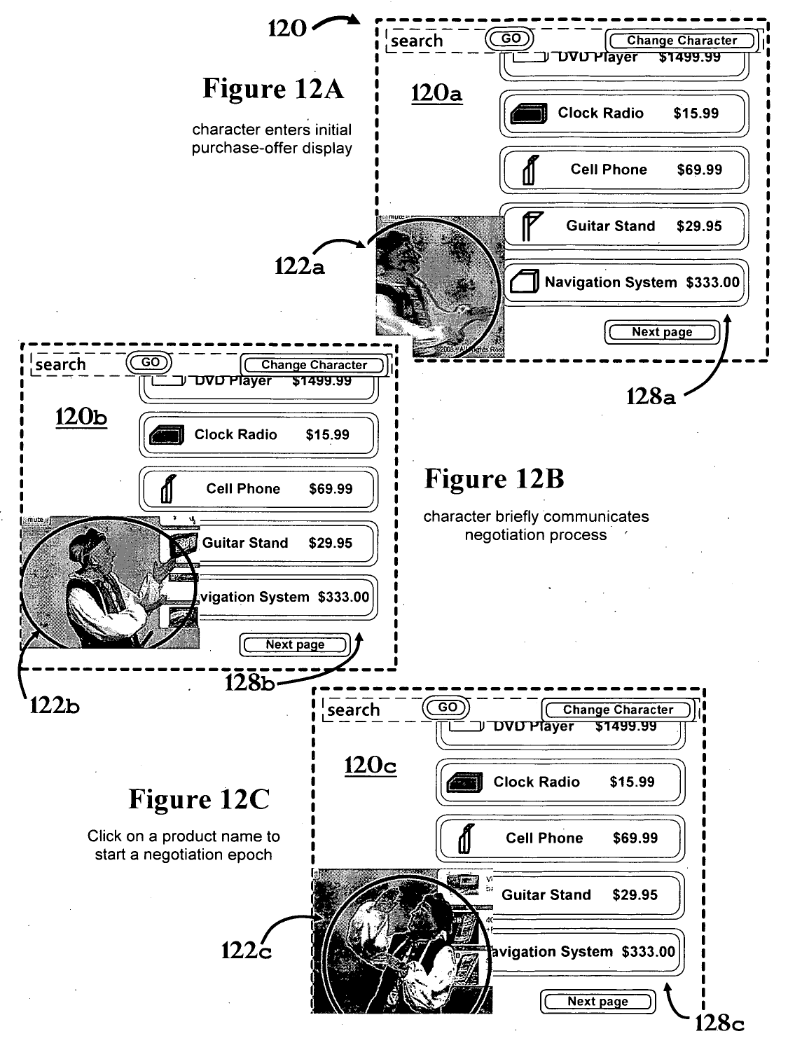

FIGS. 10 and 11 are further examples of the flexible nature of the unique technique contemplated herein: FIG. 10 depicts a display 110a of a homepage 110 hosted by an affiliate of the assignee hereof providing a variety of services and products, on which a sub-display 130a is operational containing consecutive widget displays 130a, 130b introducing a negotiation epoch/session within a host web display 110a, 110b. In FIG. 10, a plurality of product indicia 138a is displayed in scrolling fashion on initial widget display 130a, for example, to invite a user to ‘click-on’, or otherwise activate, a product indicia of choice. Once activated, display 130b opens as shown in FIG. 11 to detail the product selected by indicia 136b, at a list/retail/initial offer sale price at 114b. As in FIG. 2A, a motional graphic such as character 132b enters the widget display 130b of FIG. 11 to invite a user (once again, a user is not shown for simplicity) to either accept the list price, or make a ‘bid’, or offer to obtain rights in the product (such as, purchase) by entering numerical data at 114b.

In a manner similar to that depicted in FIGS. 1A-1B, and 2A-2D, FIGS. 12A, 12B, 12C, 12D, 12E, and 12F each depict computer implemented purchase-offer displays which illustrate a motional graphic—in this case character 122a-122f—with which a buyer/user interacting with display 120a-120f, can negotiate. Character 122a enters display 120a of screen 120 to communicate instructions, explain selections, invite an offer, or otherwise entertain; here, character 122a-122c points-out a scrolling list of product indicia 128a available for selection by a user (see, also, FIG. 8 at 141, 142 and FIG. 9 at 164, and FIG. 10 at 138a), as well as suggests in FIG. 12C that a text search may be carried out (see, top border of display 120a-120f). After one of the plurality of scrolling indicia 128a-128c is activated in a customary manner, a more-detailed product indicia 126d is displayed along with pricing/offer-request indicia 114d, FIG. 12D, permitting a user to enter numerical data concerning a term for barter (here, it is for a purchase price); see, also, FIG. 8 at 144, 146 and FIG. 9 at 164, 166, 168. In response to entry of numerical data (here, counter offer for price) at 114d, several actions take place very rapidly! as depicted at 148 of FIG. 8, and 168, 170, 174, 178, 180 of FIG. 9: (a) a {next}acceptance price is determined taking into account a Low (hidden) Price value set for the product, (b) if the numerical data entered is less-than {next}acceptance price, determine a Tier level value and associate it with the user to use in determining a Counter-Offer value, and (c) display a third (or, subsequent) motional graphic of the character 122e.

Note that, as suggested along box 147 in both FIGS. 8 and 9, a different character may be selected employing indicia such as that shown at 16d, by way of example, in FIG. 1D. By permitting a user to change theme of the bargaining motional graphic, interest is maintained throughout the barter epoch, increasing chances of mutual agreement being reached before time-out of the session or permitted total counter-offers, is exceeded—which is the case in FIG. 12F, where numerical data entered (counter-offer) 114f was accepted as communicated by an upbeat character 122f.

### EXAMPLE 01

### Features of the Invention Depicted, Include, Without Limitation

The system represented by FIGS. 8, 9, 10, 11, 12A-D, in operation, delivers stored and/or live video/movie/motional graphics (preferably with audio, but not critical) content in a real-time manner to a user of a client-device screen, in seemingly-instantaneous response to data input from the user—here, product indicia—to provide an entertaining and interactive means by which the user may bargain, or barter, for a price/instant discount(s), whether coupled with other special offers, such as future purchases. And, if no agreement is reached as to the particular term undergoing barter (e.g., purchase price, ship date, quantity for bulk purchases, interest rate and term of repayment, rental term, contract price for services, and so on), a response is communicated to the user to “try again later!” The system may deliver a response based on: current inventory level and/or availability of certain products (item(s) and/or service(s)); date and time of the offer (i.e., take into account whether negotiation epoch, i.e., total period of time during which the buyer negotiates with the character, is prior to a holiday, certain time of day, week, month, end of year)

System is adaptable for use on a PC/Mac in communication or installed on the INTERNET (or other WAN), a LAN, cell phones, mobile devices, unattended voice telephony, and unattended automated computer kiosk. System may present—through the character—a coupon, coupon code, delivery of a coupon or coupon code for a discount, link to a coupon, a printable coupon, a printed coupon, and/or a coupon sent to an email and/or physical address (e.g., “Purchase today, and a free clock radio will be included in the arrangement!” or “if you also purchase X, it may be purchased for a greater-discounted price!”). User can select an individual, group, or character from a gallery of character choices and themes at the out-set of bargain process, or during bartering process. System also recognizes previous engagements and delivers previous character. The system employs browser plug-in to locate code on designated web-pages, and if located will automatically pop-up audio and/or video to engage with site visitor for purpose of offering a discount on a certain product and/or service. As part of a negotiated arrangement, the system may apply a credit to a gift card, debit card, credit card, personal account, store account, or a rebate offer, credit card, ticket for some value.

While certain representative embodiments and details have been shown for the purpose of illustrating features of the invention, those skilled in the art will readily appreciate that various modifications, whether specifically or expressly identified herein, may be made to these representative embodiments without departing from the novel core teachings or scope of this technical disclosure. Accordingly, all such modifications are intended to be included within the scope of the claims. Although the commonly employed preamble phrase “comprising the steps of” may be used herein, or hereafter, in a method claim, the applicants do not intend to invoke 35 U.S.C. §112 ¶6 in a manner that unduly limits rights to its innovation. Furthermore, in any claim that is filed herewith or hereafter, any means-plus-function clauses used, or later found to be present, are intended to cover at least all structure(s) described herein as performing the recited function and not only structural equivalents but also equivalent structures.

### EXAMPLE 02

### By way of Example, Only, Pseudo Code for Embodiment, Shown in FIGS. 4-7

Bargain4It Pseudo Code
Initialize all constants for verbal representation of Integer variables
Declare function “DetermineCounterOffer” that accepts 3 arguments: price, bid, lowprice

Declare variables for counter offer: counteroffer, bidPercent, lowcatch
If Session(“LastOffer”) is equal to nothing

bidPercent equals bid divided by price
Session(“LastOffer”) equals price

Else

bidPercent equals bid divided by Session(“LastOffer”)

lowcatch is equal to Session(“LastOffer”) - lowprice which is then multiplied by .25 and added
back into the lowprice. This provides us a price level that is not our lowest, but the counter
offers will get closer to it.
counteroffer is equal to Session(“LastOffer”) - lowprice which is then multiplied by the
bidPercent and then subtracted from Session(“LastOffer”)
Session(“LastOffer”) = counteroffer
Function “DetermineCounteroffer” is equal to counteroffer

Declare Function “DetermineBidLevel” which accepts 2 arguments: bid, lowprice

Session(“TrackVideo”) is incremented by 1
If bid is greater than or equal to lowprice

Function “DetermineBidLevel” is equal to BidAccepted

Else if bid is less than Session(“LastBid”)

Function “DetermineBidLevel” is equal to BidLowerThanLast

Else if bid is less than lowprice and bid is greater than or equal to 90% of lowprice

Function “DetermineBidLevel” is equal to BidWithin 10

Else if bid is less than 90% of lowprice and bid is greater than or equal to 70% of lowprice

Function “DetermineBidLevel” is equal to BidWithin30

Else if bid is less than 70% of lowprice and bid is greater than or equal to 40% of lowprice

Function “DetermineBidLevel” is equal to BidWithin60

Else if bid is less than 40% of lowprice

Function “DetermineBidLevel” is equal to BidTooLow

Session(“LastBid”) = bid

Declare Function “IfBidAccepted” which accepts 4 arguments: price, cost, lowprice, bid

Create Results string which will be displayed to user on page
SetVideo to correct video path (Z1)
Add to results string the movie object (E1)
Reset Session Variables

Declare Function “IfBidsDone” which accepts 4 arguments: price, cost, lowprice, bid

Determine Counteroffer
Create Results string which will be displayed to user on page
SetVideo to correct video path (Z1)
Add to results string toe movie object (F1)
Reset Session Variables

Declare Function “IfBidWithin10” which accepts 4 arguments: price, cost, lowprice, bid

Determine Counteroffer
Create Results string which will be displayed to user on page
SetVideo to correct video path (appropriate C)
Add to results string the movie object (D1)
Reset Session Variables

Declare Function “IfBidWithin30” which accepts 4 arguments: price, cost, lowprice, bid

Determine Counteroffer
Create Results string which will be displayed to user on page
SetVideo to correct video path (appropriate C)
Add to results string the movie object (D2)
Reset Session Variables

Declare Function “IfBidWithin60” which accepts 4 arguments: price, cost, lowprice, bid

Determine Counteroffer
Create Results string which will be displayed to user on page
SetVideo to correct video path (appropriate C)
Add to results string the movie object (D3)
Reset Session Variables

Declare Function “IfBidTooLow” which accepts 4 arguments: price, cost, lowprice, bid

Determine Counteroffer
Create Results string which will be displayed to user on page
SetVideo to correct video path (appropriate C)
Add to results string the movie object (D4)
Reset Session Variables

Declare Function “IfBidLowerThanLast” which accepts 4 arguments: price, cost, lowprice, bid

Determine Counteroffer
Create Results string which will be displayed to user on page
SetVideo to correct video path (appropriate C)
Add to results string the movie object (DQ)
Re-set Session Variables

Declare Function “ProcessBidLevel” which accepts 4 arguments: bid, lowprice, price, cost

Declare variable to hold bid level “BidLevel”
Initialize “BidLevel” with function DetermineBidLevel(bid, lowprice)
Select a case based on the value of “BidLevel”

Case executes related function

We claim:

1. A computer implemented process for bartering for at least one term relating to the purchase of a product by interacting with a motional graphic displayed on a screen of a client-device, the process comprising the steps of:
(a) displaying a product indicia for each of a plurality of the products;
(b) displaying a first pre-recorded motional graphic inviting a user to barter for one of said plurality of the products;
(c) displaying an offer-request indicia permitting entry by the user of data in connection with the at least one term;
(d) in response to entry of first data, using a user interface for the client-device:
i) an acceptance price, having been determined for the product by taking into account at least a Low Price set for the product, is displayed; and
ii) if said first data entered is less than said acceptance price, display a Counter-Offer value, having been determined using a Tier level value associated with the user, along with a second pre-recorded motional graphic to aid in communicating said Counter-Offer value.

2. The computer implemented process of claim 1, wherein said first and second pre-recorded motional graphics comprise a clip of a character communicating a respective response.

3. The computer implemented process of claim 2, wherein said clip is selected from the group consisting of: a video clip of a human or other animal, a short clip of an animated cartoon personality, and a short clip of an animated motional portion of a cartoon personality.

4. The computer implemented process of claim 1, wherein said product is selected from the group consisting of: an item, a batch of items, a financial product, a service, a coupon, a combination of a plurality of different items, an item and a service, an item and a coupon, and an item and a special offer.

5. The computer implemented process of claim 1, further comprising the step of, if said first data entered is greater-than or equal-to said acceptance price, display a third pre-recorded motional graphic communicating offer acceptance.

6. A computer readable storage medium having stored thereon, program code for automatically bartering for at least one term relating to the purchase of a product by interacting with a motional graphic displayed on a screen of a client-device, the program code comprising:
(a) a first program sub-code for displaying a product indicia for each of a plurality of the products;
(b) a second program sub-code for displaying a first pre-recorded motional graphic inviting a user to barter for one of said plurality of the products by entering data in connection with the at least one term;
(c) a third program sub-code for, in response to entry of first data:
i) determining an acceptance price for the product, taking into account at least a Low Price set for the product; and
ii) if said first data entered is less than said acceptance price, determining a Counter-Offer value, using a Tier level value determined and associated with the user; and
(d) a fourth program sub-code for displaying a second pre-recorded motional graphic to aid in communicating said Counter-Offer value.

7. The program code of claim 6, wherein said first and second pre-recorded motional graphics comprise a clip of a character communicating a respective response.

8. The program code of claim 7, wherein said clip is selected from the group consisting of: a video clip of a human or other animal, a short clip of an animated cartoon personality, and a short clip of an animated motional portion of a cartoon personality.

9. The program code of claim 6, wherein said product is selected from the group consisting of: an item, a batch of items, a financial product, a service, a coupon, a combination of a plurality of different items, an item and a service, an item and a coupon, and an item and a special offer.

10. The program code of claim 6, further comprising a fifth program sub-code for, if said first data entered is greater-than or equal-to said acceptance price, displaying a third pre-recorded motional graphic communicating offer acceptance.
